(19) United States
(12) Patent Application Publication
(10) Pub. No.: US 2011/0168317 A1
(43) Pub. Date: Jul. 14, 2011

(54) Controlled Bond Wave Over Patterned Wafer

(75) Inventors: Steve Deming, San Jose, CA (US); Zhenfang Chen, Sunnyvale, CA (US); Micheal Rocchio, Hayward, CA (US); Hugo J. Miller, San Jose, CA (US)

(73) Assignee: FUJIFILM CORPORATION, Tokyo (JP)

(21) Appl. No.: 12/686,278

(22) Filed: Jan. 12, 2010

(51) Int. Cl. B29C 65/00

(52) U.S. Cl. 156/64; 156/306.3; 156/378; 257/E21.567

(57) ABSTRACT

A method of bonding two substrates includes placing a separating member between a first substrate and a second substrate, applying pressure to the first substrate to initiate a bond wave between the first substrate and the second substrates with the separating member between the first substrate and the second substrate, and controlling movement of the bond wave by translating the separating member away from a center of the first substrate or the second substrate.

### TECHNICAL FIELD

This disclosure relates to silicon substrate processing.

### BACKGROUND

A microelectromechanical system (MEMS) typically has mechanical structures formed in a semiconductor substrate using conventional semiconductor processing techniques. A MEMS can include a single structure or multiple structures. The electromechanical aspect of MEMS is that an electrical signal activates each or is produced by actuation of each structure in the MEMS.

Various processing techniques are used to form MEMS. These processing techniques can include layer formation, such as deposition and bonding, and layer modification, such as laser ablation, etching, punching and cutting. The techniques that are used are selected based on a desired pathway, recess and hole geometry to be formed in a body along with the material of the body.

One implementation of a MEMS includes a body having chambers formed therein and a piezoelectric actuator formed on an exterior surface of the body. The piezoelectric actuator includes a layer of piezoelectric material, such as a ceramic, and conductive elements, such as electrodes, on opposite sides of the piezoelectric material. The electrodes of the piezoelectric actuator can either apply a voltage across the piezoelectric material to cause it to deform, or deformation of the piezoelectric material can generate a voltage difference between the electrodes.

One type of MEMS with piezoelectric actuators is micro-fluidic ejection devices. An actuator can include piezoelectric material that can be actuated by electrodes, causing the piezoelectric material to deform. This deformed actuator pressurizes a chamber, causing fluid in the chamber to exit, for example, through a nozzle. The structure components, including the actuator, the chamber and the nozzle, can affect how much fluid is ejected. In a MEMS with multiple structures, forming uniformly sized components for each structure across the MEMS can improve the uniformity of performance of the MEMS, such as the uniformity of fluid quantities that are ejected. Forming structures with uniformity of size of a few microns can be challenging.

### SUMMARY

In general, in one aspect, a method of bonding two substrates includes placing a separating member between a first substrate and a second substrate, applying pressure to the first substrate to initiate a bond wave between the first substrate and the second substrates with the separating member between the first substrate and the second substrate, and controlling movement of the bond wave by translating the separating member away from a center of the first substrate or the second substrate.

This and other embodiments can optionally include one or more of the following features. The method can further include monitoring the bond wave as the bond wave moves between the first substrate and the second substrate. The method can further include removing the separating member from between the first substrate and the second substrate after translating the separating member. The separating member can include a tapered portion and a non-tapered portion, and removing the separating member can include removing the tapered portion after the non-tapered portion. The method can further include determining a stopping point of the bond wave, and controlling movement of the bond wave can begin after the stopping point has been determined.

The separating member can be translated at a rate that is less than a maximum rate above which voids and bubbles can be trapped between the first and second substrates. The separating member can be translated at a rate of between about 50 mm/s to 70 mm/s. Pressure can be applied at between about 0.5 psi and 5 psi, such as about 1 psi.

The first substrate or the second substrate can include a patterned region including at least one die. The method can further include positioning the substrate having the patterned region such that a length of the at least one die is positioned along an axis that is at an angle of less than 30° from an axis extending along a length of the separating member. The angle can be about 17°.

Placing the separating member between the first substrate and the second substrate can cause there to be a gap of between about 0.5 mm and 5 mm at least one point between the first substrate and the second substrate. The gap can be about 1 mm.

The separating member can be placed approximately along a radial axis of the first substrate or the second substrate, and the separating member can extend along the radial axis by an amount that is less than a radial distance of the first substrate or the second substrate. The separating member can extend about 0.5 mm to 50 mm along the radial axis. The separating member can extend about 3 mm along the radial axis.

The pressure can be applied with a manual mechanism. The pressure can be applied by air from an automated air cylinder. The bond can be further initiated by sliding a pressure mechanism across a surface of the first substrate or the second substrate. The pressure mechanism can include a compliant material. The compliant material can be rubber. The pressure can be applied at a single pressure point on the first or second substrate.

The separating member can be the only separating member between the first and second substrates.

In general, in one aspect, an apparatus for bonding two substrates includes a substrate holding member configured to hold a first substrate, a separating member configured to separate the first substrate and a second substrate, a pressure inducer configured to apply pressure to the first or second substrate and initiate a bond wave between the first substrate and the second substrate, a monitoring device configured to generate images of a bond wave between the first and second substrates, and a mechanism connected to the separating member. The mechanism is configured to translate the separating member away from a center of the first or second substrate to control movement of the bond wave.

This and other embodiments can optionally include one or more of the following features. The monitoring device can be an infrared camera. The separating member can include a tapered portion. The separating member can have a length that is less than a radial distance of the first substrate or the second substrate. The separating member can be configured to align about along a line that bisects a center of the first or second substrate and a point where pressure is applied to the first substrate or the second substrate. The apparatus can further include a handle configured to move the separating member away from the substrate holding member when not in use. The mechanism can include a pocket configured to hold the separating member when not in use. The pressure inducer can be capable of exerting a pressure on the first substrate or the second substrate at an angle other than parallel to a main surface of the first substrate. The pressure inducer can be configured to apply a pressure at an angle between 90 degrees and 45 degrees to the main surface. The pressure inducer can have a tip that is less than 5 mm in diameter. The pressure inducer can be actuatable.

By placing a separating member between two substrates and translating the separating member away from the center of the substrates, the bond wave between two substrates can be precisely controlled. Controlling the bond wave can avoid the formation of voids and bubbles between substrates. Avoiding bubbles and voids when bonding substrates can result in fewer defects in substrates, which can increase product yield. Moreover, controlling the bond wave to ensure that the bond is not defective can reduce the number of defects that need to be tested for in the completed device.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a top perspective view of a mechanical device for bonding substrates.

FIG. 2 is a bottom view of a mechanical device for bonding substrates.

FIG. 3A is a schematic of a separator unit having an extended separating member.

FIG. 3B is a schematic of a separator unit having a separating member stored in a pocket of the separator unit.

FIG. 4 is a side view of a mechanical device for bonding substrates.

FIG. 4A is close-up view of a portion of FIG. 4.

FIGS. 5A-5F, viewed from the top as if the upper substrate is transparent, show movement of an exemplary bond wave between substrates.

Like reference symbols in the various drawings indicate like elements.

### DETAILED DESCRIPTION

When two substrates are bonded together, e.g., with room temperature fusion bonding, the bond typically begins at an initial bonding region and propagates outward in a bond wave. If at least one of the substrates includes patterned or etched features, the movement of the resulting bond wave is affected by the patterned regions of the substrate. As a result, the bond wave will move faster over some areas of the substrate than other areas. Such uneven movement of the bond wave can cause voids and air bubbles to be trapped between the substrates, reducing the strength of the bond and creating defects in unbonded areas. By placing a separating member between the substrates, monitoring the bond wave as it moves between the substrates, and translating the separating member away from the center of the substrates, the bond wave can be controlled to move uniformly across the substrates and avoid the formation of voids and bubbles between the substrates. In some devices, there are features, such as recesses or apertures that are formed in one or both of the substrates. The voids and bubbles that are avoided using the techniques and devices described herein are other than desired recesses and/or apertures that are purposely formed in a substrate and required for proper device construction. In some implementations, the voids and bubbles that are created by improper bonding of two substrates are greater than 2 millimeters in diameter.

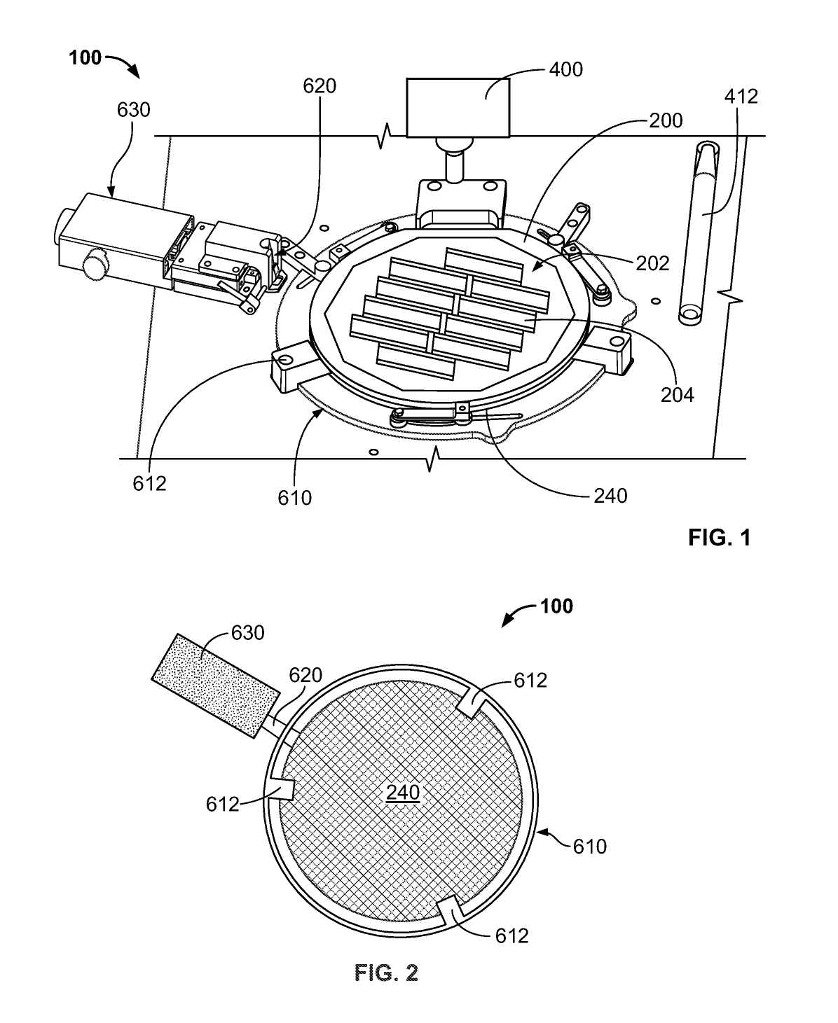

Referring to FIGS. 1 and 2, a mechanical device 100 can hold a lower substrate 240 and an upper substrate 200. The upper substrate 200 can sit on the lower substrate 240 at one edge and be angled apart from the lower substrate 240 at the opposite edge The device can include a substrate support 610 that can be actuated up and down. The substrate support 610 can include substrate holders 612, such as between three and six substrates holders, attached to the support 610. The substrate holders 612 can be configured to project inwardly from the support and to touch only a small portion of the lower substrate 240, such as a perimeter portion or edge of the substrate, thereby helping to ensure that the lower substrate 240 is kept both flat and clean. In some implementations, the substrate holders 612 are spaced to hold a 300 mm substrate. The substrate holders can be sized and positioned to accommodate other substrate sizes, such as 200 mm substrates or smaller or larger substrates.

A separator unit 630 can be used to prevent portions of the substrates 200, 240 from contacting. The separator unit 630 can include a separating member 620. The separating member 620 can project from the separator unit 630 and can be positioned to project between the main surfaces of the upper substrate 200 and the lower substrate 240, e.g., generally parallel to the surface of the lower substrate.

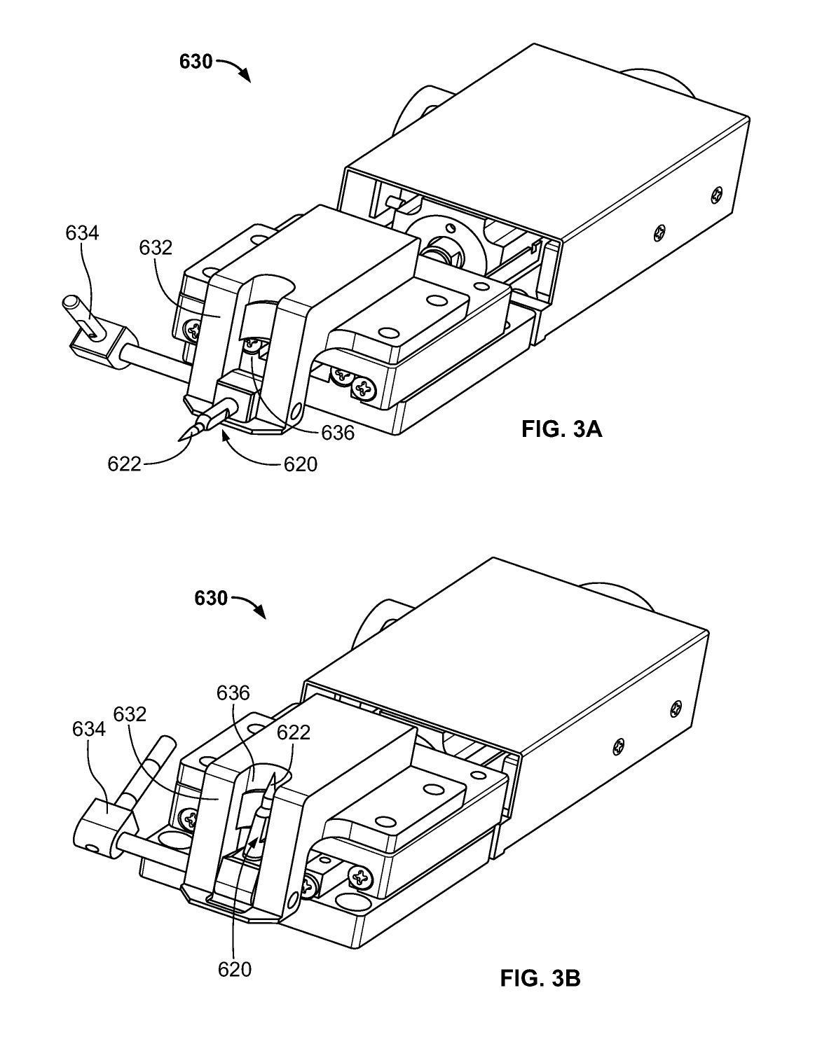

As shown in FIG. 3A, the separating member 620 can include a tapered portion 622. The tapered portion is tapered to be progressively thinner along at least one axis, e.g., its longitudinal axis, and the taper can be uniform along the length of the tapered portion 622. For example, the separating member 620 can be in the shape of a pin or a wedge. In operation, the separator unit 630 can be held such that the separating member 620 is generally parallel to the surface of the lower substrate, and the width of the tapered portion 622, as measured perpendicular to the surface of the substrates, progressively decreases toward the center of the substrates. As such, the tapered portion 622 can ensure that when the separating member 620 is removed from between the substrates 200, 240, the substrates 200, 240 gradually come together in a controlled manner, e.g., without an abrupt drop. The cross-section of the separating member 620 normal to its longitudinal axis can be circular so that the separating member 620 does not have to be precisely aligned with the main surfaces of the substrates 200, 240. The width of the separating member 620 at its thickest point can be between about 1 mm and 12 mm, such as 6 mm. The separating member 620 can have a length that is less than a radial distance of either of the substrates 200 or 240. Further, the separating member 620 can have a maximum width of less than 3 mm, for example less than 1 mm. The separating member can be made of a material that does not scratch the surfaces of the substrates 200, 240, such as plastic, ceramic, or metal, e.g., stainless steel.

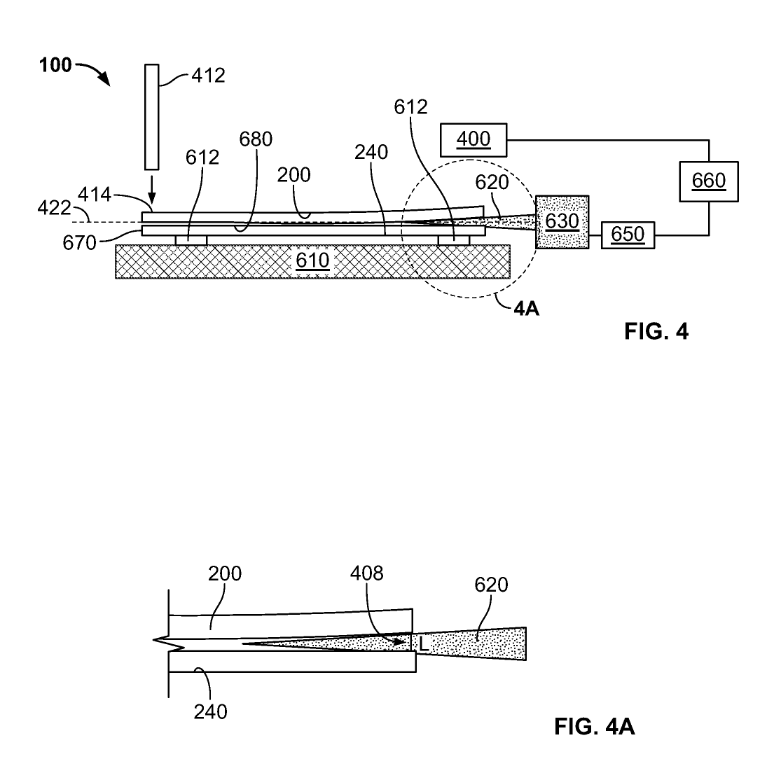

Each separator unit 630 can include a holding member 632, e.g., a clamp, for securing the separating member 620. A motor 650 (see FIG. 4), such as a stepper motor, can be configured to actuate the separator member 620 in an outward and inward direction with respect to a central axis perpendicular to the surface of the substrate support 610, as discussed further below. Thus, when the substrates 200, 240 are properly supported in the device 100 and the separator unit 630 is in operation, the separating member 620 can move inward or outward along an axis parallel to the surfaces of the substrate. The motor 650 can either be part of the separator unit 630 or a separate unit.

In some implementations, the separating member 620 can be mounted on the clamp 632 such that it can pivot freely in the vertical direction, i.e. rather than being mounted rigidly in the clamp 632. Mounting the separating member 620 to pivot freely in the vertical direction can both facilitate alignment of the separating member 620 and facilitate loading of substrates 200, 240. For example, if the separating member is mounted to pivot freely in the vertical direction, then the separating member can be pivoted such that both substrates 200, 240 follow the taper as the separating member is removed to ensure that the substrates 200, 240 will come together smoothly.

The separator unit 630 can further include a handle 634 to move the separating member 620 from an extended state as shown in FIG. 3A to a retracted state as shown in FIG. 3B. In the retracted state, the separating member 620 can be located in a pocket 636 of the separator unit 630 away from the substrate support 610. Placing the separating member 620 in the pocket 636 can avoid damage to the separating member 620, e.g., the tapered portion 622 or sharp point of the separating member, when not in use. The handle 634 can further be used to move the separating member 620 out of the way before loading the lower substrate 240 and then to lower the separating member 620 before loading the upper substrate 200. Optionally, the handle 634 can be automated, for example using an air cylinder. The automated process can cause the separating member 620 to automatically retract after the substrates 200, 240 have been bonded together.

As shown in FIG. 4, the mechanical device can also include a monitoring device 400, such as an infrared camera, to generate images of a bond wave between the substrates 200, 240. The monitoring device 400 and/or the motor 650 can be connected to a controller 660.

In operation, a lower substrate 240 is placed on the substrate holders 612 of the substrate support 610, the separating member 620 is lowered, and then the upper substrate 200 is placed on top of the supported lower substrate 240 at one edge and on the separating member 620 on the opposite edge. The substrates can be, for example, silicon or piezoelectric (e.g. PZT) substrates. The interface between the two substrates 200, 240 can be, for example, silicon-to-silicon, silicon-to-oxide, oxide-to-oxide, or BCB-to-silicon. One substrate can be, for example, a sacrificial substrate.

At least one of the substrates can have an etched or patterned portion 202, as shown in FIG. 1. The surface having the patterned portion 202 can have recesses on the surface at the interface between the two substrates that extend only partially through the substrate, or, as shown in FIG. 1, the patterned portion of the substrate can have apertures that extend all the way through the substrate. In some implementations, the patterned portion 202 includes inlet channels or pumping chambers for use in an ink jet printer. In some implementations, the patterned portion 202 has features, i.e., recesses or apertures, that are grouped into dies 204. At some point during the process, the dies can be removed from the substrates. However, after the bonding step, multiple dies can remain part of an integral substrate. In some implementations, the dies have a length in one direction that is greater than a width in a perpendicular direction.

The substrates and separating member 620 can be positioned so that an axis through a center of the length of the separating member 620 can be at an angle to an axis that runs along a length of ones or more of the dies 204. The angle can be less than 30°, such as about 17° or about 0° (i.e., be parallel). Further, the separating member can be aligned approximately along an axis that intersects the center of the substrates 200, 240, i.e. is aligned along a radial axis of the substrates 200, 240.

Referring back to FIG. 4, the separating member 620 can be moved in toward the center of the substrates 200, 240 along an axis 422 parallel to the plane defined by the substrate holders 612 using the motor 650. The distance at which the separating member 620 is placed along the radial axis of the substrates can be determined based upon the ability of the substrates 200, 240 to bond. For example, if the separating member 620 is placed too far in between the substrates 200, 240, then the substrates will not be able to bond together due to the amount of space between them. Therefore, the separating member 620 can be extended between the substrates 200, 240 by less than a radial distance, such as 0.5 mm to 50 mm, for example 3 mm. In some implementations, the separating member 620 can be permanently mounted in the desired alignment so that additional alignment is not necessary.

Referring to FIGS. 4 and 4A, the separating member 620 can cause the substrates 200, 240 to separate and form a gap 408 between the substrates at the edge of the substrates. The maximum gap length L at the edge of the substrates can be about 0.5 mm to 5 mm.

After the separating member 620 has been placed between the substrates 200, 240, a pressure can be applied to the substrates 200, 240, such as by pressing on upper substrate 200. The pressure can be applied at a point 414 that is about 180° from the separating member 620, i.e., the pressure point can be applied on the opposite side of the substrates 200, 240 as the separating member 620. In some implementations, the pressure point is close to the substrates' edge. The pressure can be applied with a pressure inducer 412, which can be manually actuatable. Alternatively, the pressure inducer 412 can be an automated pressure inducer that actuates on a signal from the controller 660. The pressure inducer 412 can be made, for example, of a resin, such as polypropylene, for example, if it is a manual pressure inducer. The pressure inducer 412 can also be made, for example, of a compliant material, such as rubber, for example if it is an automated pressure inducer, so that when the inducer contacts the surface, it can flex and slide slightly across the surface of the substrate to initiate the bond between the two substrates 200, 240. The pressure inducer can have a tip that is less than 5 mm in diameter. Alternatively, the pressure inducer 412 can be an air cylinder, which ejects air onto the substrates to put pressure between the two substrates. The pressure inducer 412 is capable of exerting a pressure on the upper substrate 200 that is at an angle other than parallel to the main surface 680 of the lower substrate 240, for example at an angle of between 45° and 90° with the surface 680. A pressure of between about 0.5 psi and 5 psi, such as about 1 psi can be applied with the pressure inducer 412 at the pressure point 414.

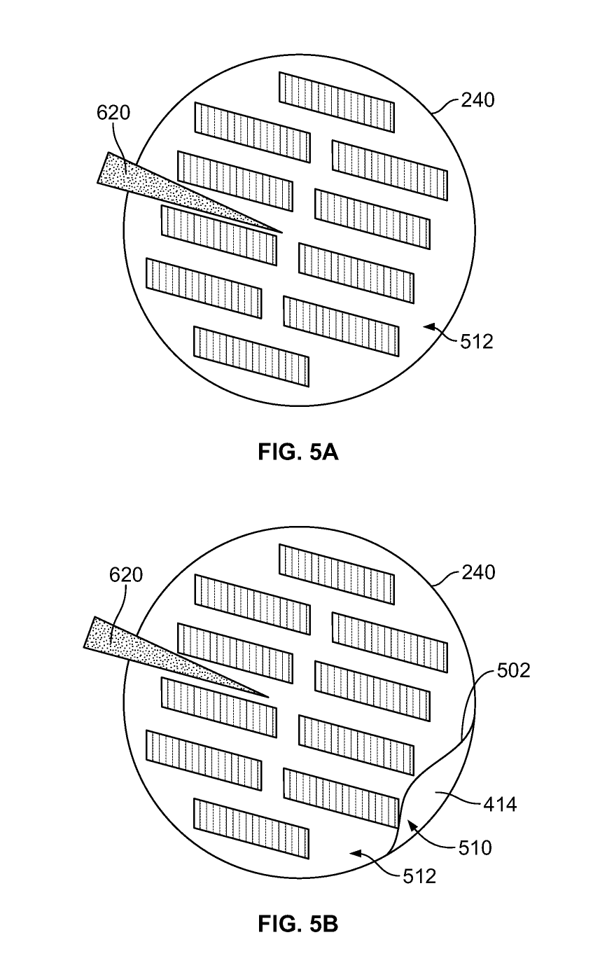

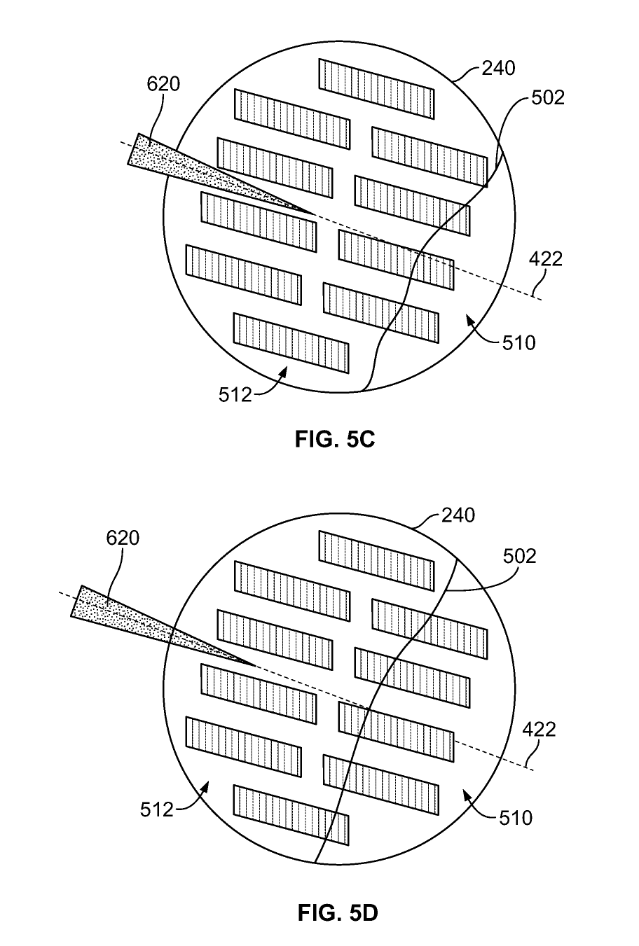

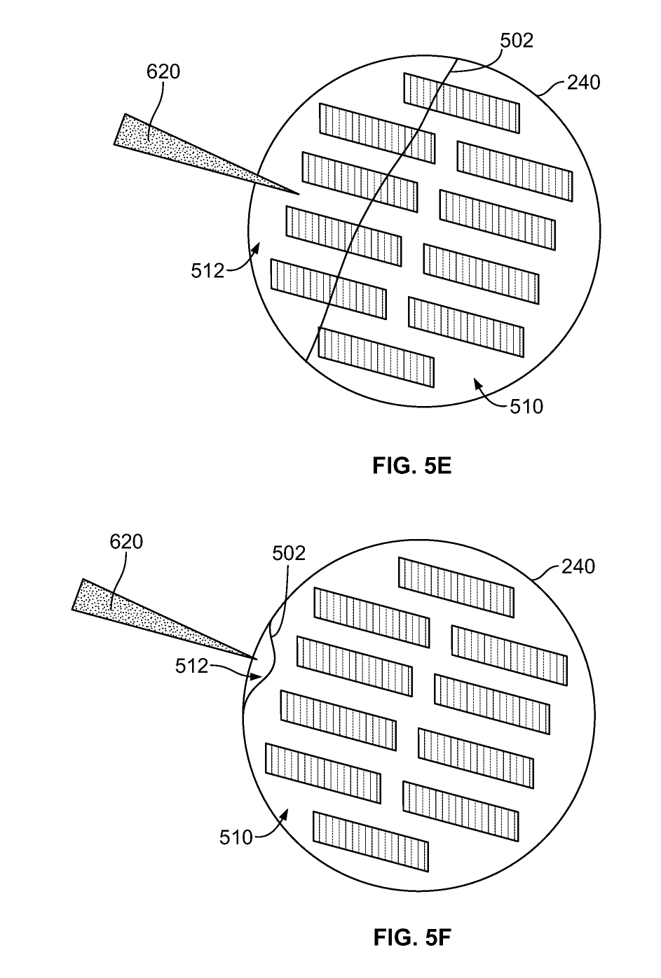

Referring to FIGS. 5A-5C, the pressure can initiate room temperature fusion bonding between the substrates 200, 240 of a substrate assembly (upper substrate 200 is treated as transparent to show the bond wave). Fusion bonding, which creates Van der Waals bonds between the two surfaces, occurs when two flat, highly polished, clean surfaces are brought together with no intermediate adhesive layer between the surfaces. Referring to FIG. 5B, the initial pressure application at pressure point 414 will start a bond between the substrates 200, 240. The edge 502 of the bond (i.e., the edge that divides the bonded portion 510 from the unbonded portion 512) can be called the bond front. Starting from the regions closest to the bond front 502, the remaining portions of the substrates will then be attracted to one another due to Van der Waals forces. As a result, shown in FIGS. 5A-5C, the bond front 502 propagates across the substrates. This traveling of the bond front can be called a “bond wave.”

As the substrates 200, 240 are bonded together, the bond wave can be monitored using the monitoring device 400. The monitoring device can reveal the position of the bond front 502 between the substrates 200, 240. At a certain point, for example when the monitoring device 400 shows that the bond wave has stopped due to the separating member 420 pulling the substrates 200, 240 too far apart to bond, or when a sensor detects a particular position of the bond wave, the separating member 620 can be translated radially away from a center of the substrates 200, 240 along the axis 422, for example using the motor 650. As shown in FIG. 4, the lower substrate 240 has a primary face 680 and a thin side 670. The separating member 620 moves in a direction perpendicular to the thin side 670 of the substrates and parallel to the primary face 680. The separating member 620 can be translated at a rate that is less than a maximum rate above which voids and bubbles can be trapped between the substrates 200, 240. For example, the separating member 620 can be translated at between about 50 mm/s and 75 mm/s. The rate at which the separating member 620 moves can be controlled, for example, using the controller 660.

The rate at which the separating member 620 is translated can relate to the rate at which the bond front 502 propagates across the substrates. Further, the rate at which the bond front 502 propagates can relate to the activation level of the substrates 200, 240. For example, a silicon-to-silicon bond is considered highly active and bonds quickly, causing the bond front to move quickly across the substrates. As a result, the rate of translation of the separating member can be faster. If, however, one of the substrate surfaces is contaminated, then the substrates will be less active, and the bond front will move slower. As a result, the rate of translation of the separating member may be slower. Similarly, a silicon-to-oxide bond or oxide-to-oxide is less active than a silicon-to-silicon bond, so the bond front moves slower across the substrates, and the rate of the separating member may therefore also be slower than with the silicon-to-silicon bond.

Referring to FIGS. 5D-5F, the movement of the separating member 620 can be controlled to ensure that the bond wave moves evenly across the substrates 200, 240. That is, as the separating member 620 is translated, portions of the substrates 200, 240 that are unbonded due to the gap between them are brought close enough that Van der Waals forces can create a bond. A velocity profile can be created based on the speed of the bond wave at different points between the substrates and to determine the resulting rate of translation of the separating member 620 and the time at which the translation should begin. For example, if the bond wave speeds up near the end, then the separator can slow down near the end to slow down the bond wave, and vice versa. Because the translation of the separating member 620 can be controlled, the speed of the bond wave can be controlled to ensure that the bond wave moves evenly across the substrate. In some implementations, the bond front 502 is controlled to remain about straight or linear as it moves between the substrates 200, 240. The process continues until the separating member 620 has been removed completely from between the substrates 200, 240 and the substrates 200, 240 are fully bonded together.

When fusion bonding is used to bond two substrates together without using a separating member as described herein, the movement of the bond front can be uneven. For example, the bond wave can move slower across patterned areas than nonpatterned areas. Likewise, the bond wave can move slower across patterned areas with deep etchings than patterned areas with shallow etchings. In some cases, the bond wave can move around a circular area between the two substrates, creating an area of trapped air that prevents the substrates on either side of the air bubble from coming in close enough contact to form the requisite Van der Waals bonding. Thus, uneven movement can cause voids and air bubbles to be trapped between the substrates, which can reduce the effectiveness of the bond or even form defectively bonded dies or devices. By translating the separating member away from the center of the substrates, the bond wave between the substrates 200, 240 can be precisely controlled so that the bond front moves straight across the substrates. That is, the bond front does not move such that two portions of the front move faster across the substrates than a third portion between the two portions and meet one another, trapping the third portion of the front as an edge of an air bubble. As a result of using the separator described herein, the bond wave can be forced to move across all portions of the substrates, e.g. portions that are deeply etched, shallowly etched, or not etched, at about the same rate, thereby significantly reducing or avoiding the generation of voids or air bubbles between the substrates.

A number of embodiments of the invention have been described. Other embodiments are within the scope of the following claims.

What is claimed is:

1. A method of bonding two substrates, comprising:
placing a separating member between a first substrate and a second substrate;
with the separating member between the first substrate and the second substrate, applying pressure to the first substrate to initiate a bond wave between the first substrate and the second substrates; and
controlling movement of the bond wave by translating the separating member away from a center of the first substrate or the second substrate.

2. The method of claim 1, further comprising monitoring the bond wave as the bond wave moves between the first substrate and the second substrate.

3. The method of claim 1, further comprising removing the separating member from between the first substrate and the second substrate after translating the separating member.

4. The method of claim 3, wherein the separating member comprises a tapered portion and a non-tapered portion, and wherein removing comprises removing the tapered portion after the non-tapered portion.

5. The method of claim 1, further comprising determining a stopping point of the bond wave, wherein controlling movement of the bond wave begins after the stopping point has been determined.

6. The method of claim 1, wherein the separating member is translated at a rate that is less than a maximum rate above which voids and bubbles can be trapped between the first and second substrates.

7. The method of claim 1, wherein the separating member is translated at a rate of between about 50 mm/s to 70 mm/s.

8. The method of claim 1, wherein pressure is applied at between about 0.5 psi and 5 psi.

9. The method of claim 8, wherein pressure is applied at about 1 psi.

10. The method of claim 1, wherein the first substrate or the second substrate comprises a patterned region including at least one die.

11. The method of claim 10, further comprising positioning the substrate having the patterned region such that a length of the at least one die is positioned along an axis that is at an angle of less than 30° from an axis extending along a length of the separating member.

12. The method of claim 11, wherein the angle is about 17°.

13. The method of claim 1, wherein placing the separating member between the first substrate and the second substrate causes there to be a gap of between about 0.5 mm and 5 mm at least one point between the first substrate and the second substrate.

14. The method of claim 13, wherein the gap is about 1 mm.

15. The method of claim 1, wherein the separating member is placed approximately along a radial axis of the first substrate or the second substrate, the separating member extending along the radial axis by an amount that is less than a radial distance of the first substrate or the second substrate.

16. The method of claim 15, wherein the separating member extends about 0.5 mm to 50 mm along the radial axis.

17. The method of claim 16, wherein the separating member extends about 3 mm along the radial axis.

18. The method of claim 1, wherein the pressure is applied with a manual mechanism.

19. The method of claim 1, wherein the pressure is applied by air from an automated air cylinder.

20. The method of claim 1, wherein the bond wave is further initiated by sliding a pressure mechanism across a surface of the first substrate or the second substrate.

21. The method of claim 20, wherein the pressure mechanism comprises a compliant material.

22. The method of claim 21, wherein the compliant material is rubber.

23. The method of claim 1, wherein pressure is applied at a single pressure point on the first or second substrate.

24. The method of claim 1, wherein the separating member is the only separating member between the first and second substrates.

25. An apparatus for bonding two substrates, comprising:
a substrate holding member configured to hold a first substrate;
a separating member configured to separate the first substrate and a second substrate;
a pressure inducer configured to apply pressure to the first or second substrate and initiate a bond wave between the first substrate and the second substrate;
a monitoring device configured to generate images of a bond wave between the first and second substrates; and
a mechanism connected to the separating member, wherein the mechanism is configured to translate the separating member away from a center of the first or second substrate to control movement of the bond wave.

26. The apparatus of claim 25, wherein the monitoring device is an infrared camera.

27. The apparatus of claim 25, wherein the separating member includes a tapered portion.

28. The apparatus of claim 25, wherein the separating member has a length that is less than a radial distance of the first substrate or the second substrate.

29. The apparatus of claim 25, wherein the separating member is configured to align about along a line that bisects a center of the first or second substrate and a point where pressure is applied to the first substrate or the second substrate.

30. The apparatus of claim 25, further comprising a handle configured to move the separating member away from the substrate holding member when not in use.

31. The apparatus of claim 30, wherein the mechanism includes a pocket configured to hold the separating member when not in use.

32. The apparatus of claim 25, wherein the pressure inducer is capable of exerting a pressure on the first substrate or the second substrate at an angle other than parallel to a main surface of the first substrate.

33. The apparatus of claim 32, wherein the pressure inducer is configured to apply a pressure at an angle between 90 degrees and 45 degrees to the main surface.

34. The apparatus of claim 25, wherein the pressure inducer has a tip that is less than 5 mm in diameter.

35. The apparatus of claim 25, wherein the pressure inducer is actuatable.
